(19) United States
(12) Patent Application Publication
(10) Pub. No.: US 2020/0382696 A1
(43) Pub. Date: Dec. 3, 2020

(54) SELFIE AERIAL CAMERA DEVICE

(71) Applicant: AirSelfie, Inc., Minneapolis, MN (US)

(72) Inventors: Marco Stroppiana, Minneapolis, MN (US); Edoardo Stroppiana, Minneapolis, MN (US)

(21) Appl. No.: 16/885,954

(22) Filed: May 28, 2020

Related U.S. Application Data
(60) Provisional application No. 62/880,165, filed on Jul. 30, 2019.
(60) Provisional application No. 62/853,385, filed on May 28, 2019.

(51) Int. Cl. H04N 5/232; G06K 9/00; H04N 7/18; G05D 1/00; G05D 1/10

(52) U.S. Cl. CPC H04N 5/23219; G06K 9/00255; H04N 7/185; G05D 1/101; G06K 9/0063; G05D 1/0094; H04N 5/23203

(57) ABSTRACT

Systems and techniques for an autonomous selfie aerial camera system are described herein. In an example, an autonomous aerial camera device is adapted to receive an initiation to perform a capture sequence with a camera of the aerial camera device. The aerial camera device may be further adapted to control a motor coupled to a propeller to automatically cause the aerial camera device to fly to a specified distance and altitude away from a starting point. The aerial camera device may be further adapted to determine the aerial camera device is positioned at the specified distance and altitude, to then initiate the capture sequence, where the capture sequence includes capturing an image with the camera or capturing a video with the camera. The aerial camera device may be further adapted to receive images from the camera of a user and identify a gesture performed by the user.

### CLAIM OF PRIORITY

This application claims the benefit of priority to U.S. Provisional Applications Nos. 62/853,385, filed May 28, 2019, titled “Selfie Drone Camera System”; and 62/880,165, filed Jul. 30, 2019, titled “Selfie Drone Camera System”, each of which is hereby incorporated herein by reference in its entirety.

### TECHNICAL FIELD

Embodiments described herein generally relate to autonomous can era systems, and more particularly to the field of selfie aerial autonomous camera devices.

### BACKGROUND

Selfie photography is one of the most common uses of smart phones. Selfie sticks, which allow a user to hold his or her smart phone at a distance in order to capture a selfie, allow the field of view for a selfie to be improved over holding the smart phone at arm's length. Some drones extend the capabilities of selfie sticks by allowing a user to obtain a selfie photograph at greater distances and at an elevation. This technology, however, has heretofore had more limited adoption than selfie sticks due to cost and complexity.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a simplified block diagram of an aerial camera device, in accordance with some embodiments.

FIG. 2 illustrates an example user interface of an aerial camera device control application, in accordance with some embodiments.

FIG. 3 illustrates an example of an aerial camera device in selfie mode, in accordance with some embodiments.

FIG. 4 illustrates an example of an aerial camera device in follow mode, in accordance with some embodiments.

FIG. 5A illustrates an example hover process for a one touch hover mode of an aerial camera device, in accordance with some embodiments.

FIG. 5B illustrates an example complete zoom process for a one touch complete zoom mode of an aerial camera device, in accordance with some embodiments.

FIG. 5C illustrates an example selfie process for a one touch selfie mode of an aerial camera device, in accordance with some embodiments.

FIG. 5D illustrates an example follow process for a one touch follow mode of an aerial camera device, in accordance with some embodiments.

FIGS. 6A and 6B illustrate flight gestures for controlling the aerial camera device to perform a side orbit, in accordance with some embodiments.

FIG. 7 illustrates a flight gesture for controlling the aerial camera device to perform a zoom in, in accordance with some embodiments.

FIG. 8 illustrates a flight gesture for controlling the aerial camera device to perform a zoom out, in accordance with some embodiments.

FIG. 9 illustrates a flight gesture for controlling the aerial camera device to perform a landing, in accordance with some embodiments.

FIG. 10 illustrates a shooting gesture for taking a photo with the aerial camera device, in accordance with some embodiments.

FIG. 11 illustrates a shooting gesture for taking a video with the aerial camera device, in accordance with some embodiments.

FIG. 12 illustrates a flow diagram of an example of a technique for a selfie aerial camera system, according to an embodiment.

FIG. 13 is a block diagram illustrating an example of a machine upon which one or more embodiments may be implemented.

### DETAILED DESCRIPTION

A drone or unmanned aerial vehicle (UAV) may have a camera attached to capture images and video from the vantage point of the drone. The drone may be capable of capturing images from a vantage point that would otherwise be unattainable based on the drone's three axis range of movement and being able to reach further heights and distances. One such use is the ability for a person to capture an image of themselves, or a “selfie”. Instead of holding a camera at arm's length or with the assistance of a selfie stick, a person may use a drone to fly to a greater distance and height for capturing a picture of themselves. However, this may have drawbacks as the person may have to control the drone to fly and capture the picture and thus not allowing the person to capture a natural picture of themselves.

The methods and techniques described herein are for an aerial camera device capable of automatically travelling to a distance and height for capturing images of the operator and others. This may include the use of facial detection to determine the subjects are facing the aerial camera device.

According to one example embodiment, method, and apparatus are provided to operate an aerial camera device, including controlling an aerial camera device from a smart phone application. The smart phone may include a touch-screen display. In one embodiment, the application may display a control panel on the touch-screen of the smart phone. The control panel may include a live image display of streaming images or video from the aerial camera device. A joystick control element may be displayed below the live image display. The joystick control element may control the aerial camera device while it is flying in a manual control mode.

According to one example embodiment, the application is responsive to the motion and orientation of the smart phone, as well as commands entered into the control panel using presses and swipes on control elements. According to other embodiments, an autonomous selfie mode of operation provides for autonomous capture of selfie photos and videos. Various other user interface and control features may enable intuitive use of the aerial camera device by consumers and non-experts.

The aerial camera device may be controlled through a wireless connection with a controller unit. A controller unit may be a computing device, such as a smart phone. According to one embodiment, a controller unit comprises a smart phone and a smart phone application installed on the smart phone. A smart phone may be, in one example embodiment, an iPhone® smart phone sold by Apple Corporation, or, in another example embodiment, an Android® smart phone, sold by any one of a number of Android® smart phone manufacturers. The smart phone application may be downloaded from, for example, the Apple® App Store, in the case of an Apple® iPhone®, or from the Google Play Store, in the case of an Android® compatible smart phone.

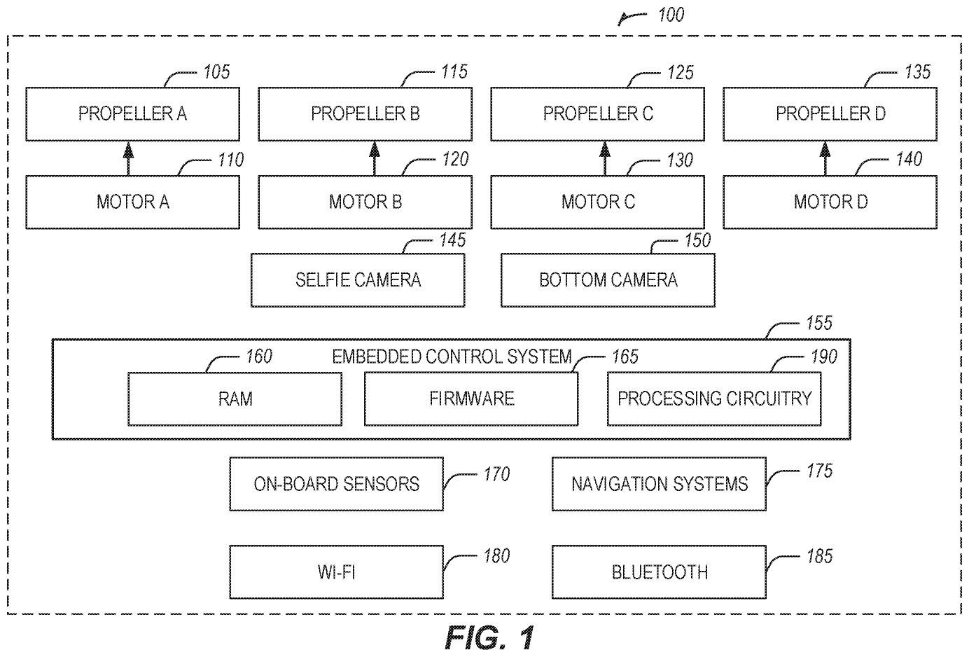

FIG. 1 illustrates a simplified block diagram of an aerial camera device 100, in accordance with some embodiments. Aerial camera device 100 may include propeller A 105, propeller B 115, propeller C 125, and propeller D 135 with corresponding motors, motor A 110, motor B 120, motor C 130, and motor D 140, for operating the propellers. The aerial camera device 100 may have any number of propellers and corresponding motors in different embodiments. The aerial camera device 100 may include a rechargeable battery power source, to supply power to the electrical components such as the motors, onboard sensors 170, and embedded control system 155.

The aerial camera device may have at least one camera, such as selfie camera 145 and bottom camera 150. The selfie camera 145 may be mounted with its lens pointing outward from the front of the aerial camera device 100, the front being defined by the side of the aerial camera device 100 facing in the direction of forward flight of the aerial camera device 100. Accordingly, the field of view of the selfie camera 145 is generally the area forward of the aerial camera device 100. Bottom camera 150, in one example embodiment, may be mounted with its lens pointing generally downwardly from the bottom surface of the aerial camera device 100, with its field of view generally down and forward oriented.

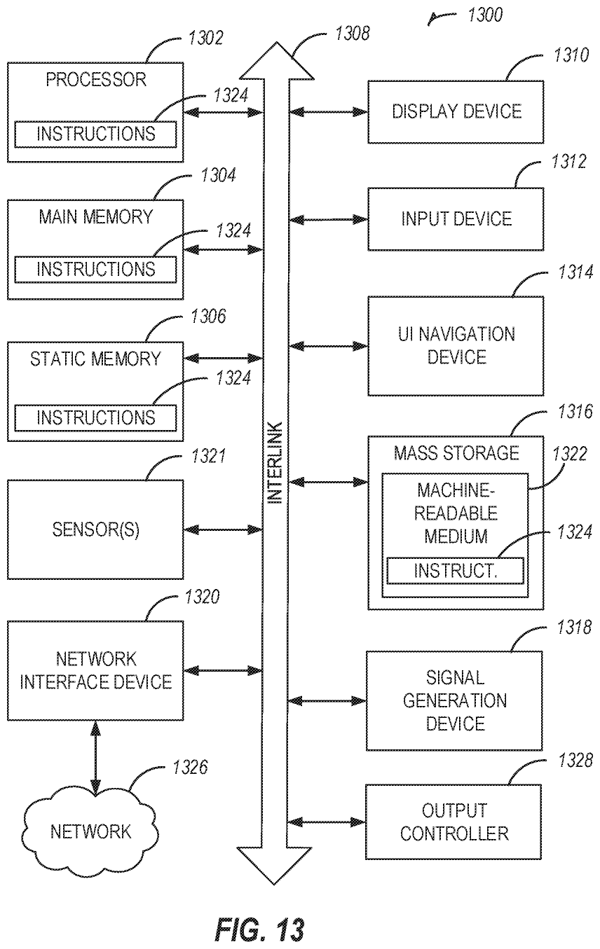

The aerial camera device 100 may include an embedded control system 155. The embedded control system 155 may be a computing system including a processing circuitry 190, an operating system, and firmware 165 with computer instructions and stored parameters and data used to control the aerial camera device 100 with selfie camera 145 and bottom camera 150. The embedded control system 155 may include computing components including processing circuitry 190 such as a processor and random access memory 160 for data storage, as well as network interfaces, peripherals, and components, such as described below with respect to FIG. 13. According to one example embodiment, firmware 165 may be updated from time to time to patch bugs and introduce new operational features by executing a firmware update routine, as are well known in the art.

The aerial camera device 100 may include, in one example embodiment, a WiFi® interface 180, and a BlueTooth® interface 185, or other wireless communication capabilities. The aerial camera device 100 may communicate with the controller unit using the WiFi® interface 180 or the BlueTooth® interface 185. The aerial camera device 100 may user the WiFi® interface 180 or the BlueTooth® interface 185 to network and communicate with other computer systems, such as for transmitting the images and video captured with the selfie camera 145. The aerial camera device 100 may transmit images and video to a cloud storage system.

According to one example embodiment, onboard sensors 170 of the aerial camera device 100 may include proximity sensors, such as for preventing the aerial camera device 100 from hitting objects. The proximity sensors may be mounted on the top, bottom, and sides of the aerial camera device 100, to detect proximity to an object such as a wall, ceiling, or floor, when flying indoors, or in addition trees and other objects or structures when flying outside. The onboard sensors 170 may include a microphone for capturing sound, such as when recording a video with the selfie camera 145.

The onboard sensors 170 may include sensors for navigation, such as an accelerometer, a gyroscope, a tilt sensor, and a magnetometer, that allow for detection of the motion of the aerial camera device 100. The onboard sensors 170 may include a global positioning system (UPS) to detect the UPS coordinates of the aerial camera device 100 based on GPS satellite signals. The data collected from the onboard sensors 170 may be used by the navigation system 175 for controlling the flight and aerial position of the aerial camera device 100. In an embodiment, aerial camera device 100 may not include one of the navigation sensors, such as UPS, for instance when only indoor operation is contemplated.

According to one example embodiment, to allow communication between the smart phone application and aerial camera device 100, a connection may be established. This connection may be carried out either before executing the application or through functions provided in the application itself, by connecting the smart phone to a WiFi® network provided by the aerial camera device 100. To establish the connection, the aerial camera device 100 may be powered on by pressing an On/Off Button. A light may blink, for example a blue light in one embodiment, when aerial camera device 100 is successfully turned on. Once the aerial camera device 100 is operating, the smart phone may be connected to the aerial camera device's 100 WiFi® network using a utility provided by the smart phone application. According to an example embodiment, the aerial camera device 100 includes a calibration mode to initialize the onboard sensors 170 used for flight. The calibration may establish a baseline parameter representing a “level” status The level status may be established by placing the aerial camera device 100 on a flat horizontal surface with the top side facing up.

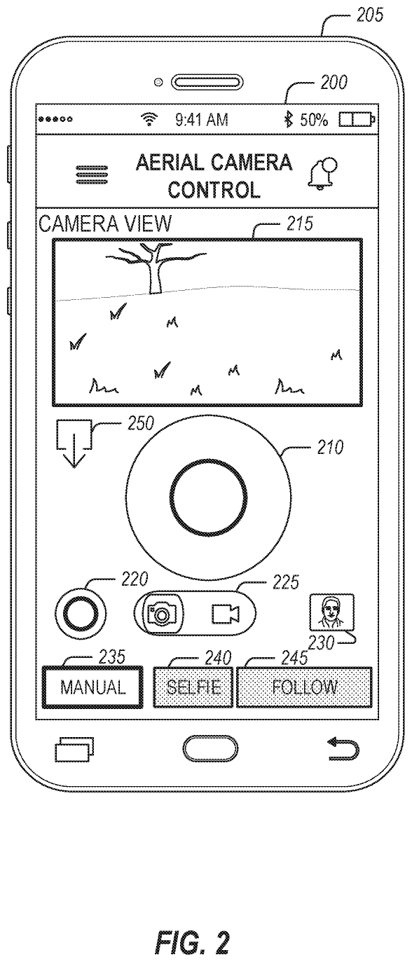

FIG. 2 illustrates an example user interface of an aerial camera device control application, in accordance with some embodiments. The application 200 may execute on a smart phone 205 and be displayed on a screen of the smart phone 205. The screen of the smart phone 205 may be a touchscreen to allow for a user to control the application 200. The application 200 may have different user interfaces for performing operations with aerial camera device. Ha 2 illustrates an example of a user interface of the application 200 for controlling the aerial camera device and viewing the current image captured by a camera of the aerial camera device.

The application 200 includes a camera view 215, which displays images streaming from a selected camera of the aerial camera device. The application 200 includes a joystick 210 for controlling the flight of the aerial camera device. The shutter button 220 may capture the current view of the camera as an image when in photo mode or may start and stop a video recording when in video mode. A user may switch from photo mode to video mode or vice versa by clicking the capture mode button 225. The user may access a photo gallery of images by selecting the gallery image 230 of the last photo or video taken.

While viewing the photo gallery, a user may select an image to perform different photo editing techniques on the photo. Photo editing techniques may, include adding stickers to the photo—including animated stickers, cropping the photo, and applying filters to the photo. The photo editing techniques may include adding text to the photo and adjusting different levels of the photo, such as brightness and contrast. The same photo editing techniques may be applied to a video. The photo gallery may include options for the user to upload the photo or video to different social media platforms or transmit the photo or video to another user over email or a messaging service.

The user may select the mode of operation for the aerial camera device. The manual button 235 allows the user to control the flight and image capture manually through the application 200, such as with the joystick 210 and the shutter button 220. The manual button 235 may put the aerial camera device in manual mode where a user controls the aerial camera device's flight height, rotation, and direction with the joystick and takes photos and videos with the shutter button 220.

The selfie button 240 may put the aerial camera device in a selfie mode and may initiate a preprogrammed capture sequence for the aerial camera device to fly to a predetermined distance and altitude to then capture an image or video (e.g., a selfie), of the user, and optionally hover or return after capturing the image or video. The follow button 245 may put the aerial camera device in a follow mode and may initiate a preprogrammed operation for the aerial camera device to automatically follow the user, such as using face detection to track the user. For the purposes of this application, it should be understood that the altitude of the aerial camera device is relative to the local ground level or a starting altitude and not a true altitude relative to sea level.

The selfie button 240 may include an outdoor option. In the outdoor mode the aerial camera device may fly autonomously, similarly to the selfie mode, however the flight routine may differ. For example, in outdoor mode, the aerial camera device may fly to a greater distance and altitude than the selfie mode.

For any of the modes, the aerial camera device may start its flight by lying flat on the palm of the user's hand with the top facing up and the selfie camera facing towards the user. According to one example embodiment, if the user needs to manually stop the aerial camera device while it is flying, the user may grab the aerial camera device and rotate it upside down. By doing so, the rotors may automatically stop.

The altitude of the aerial camera device may be controlled by swiping the joystick either up (towards the top of smart phone screen) or down (towards the bottom of smart phone screen). Swiping the joystick up causes the aerial camera device to move upwards while swiping the joystick down causes it to move downwards. The right and left rotation of the aerial camera device may be controlled by swiping the joystick right or left. Swiping the joystick to the right causes the aerial camera device to rotate clockwise while swiping the joystick to the left causes it to rotate counter-clockwise.

The user may control the direction of flight for the aerial camera device by tilting the smart phone. For example, starting from a horizontal level position dipping the top of smart phone downwards directs aerial camera device to move straight ahead, while dipping the bottom of smart phone, or raising the top of the smart phone, causes it to move backwards. To pilot aerial camera device to the right or left the user tilts smart phone to the right to make it go to the right or tilt smart phone to the left to make the aerial camera device go left. Releasing the joystick may direct the aerial camera device to hover in its current position in the air.

While the aerial camera device is in selfie mode, a pause button may appear on the screen of the smart phone 205. The user may press the pause button to deactivate selfie mode. When selfie mode is deactivated, the aerial camera device may enter a hover at its current position or return to a starting location. The aerial camera device and the application 200 may enter manual mode. The user may control the aerial camera device with the joystick 210 and the other controls of the application, as previously described. The user may press the selfie button 240 to return the aerial camera device to selfie mode, where it may resume the previous selfie mode sequence or start a new selfie mode sequence.

To land the aerial camera device, the user may press the landing icon 250 and initiate the landing sequence. The camera view 215 may display a status while the aerial camera device is landing, such “landing in progress”, and may display a second status when the landing is completed, such as “landed”. The aerial camera device may land itself in some situations, such as a low battery, completion of a capture sequence, or the like.

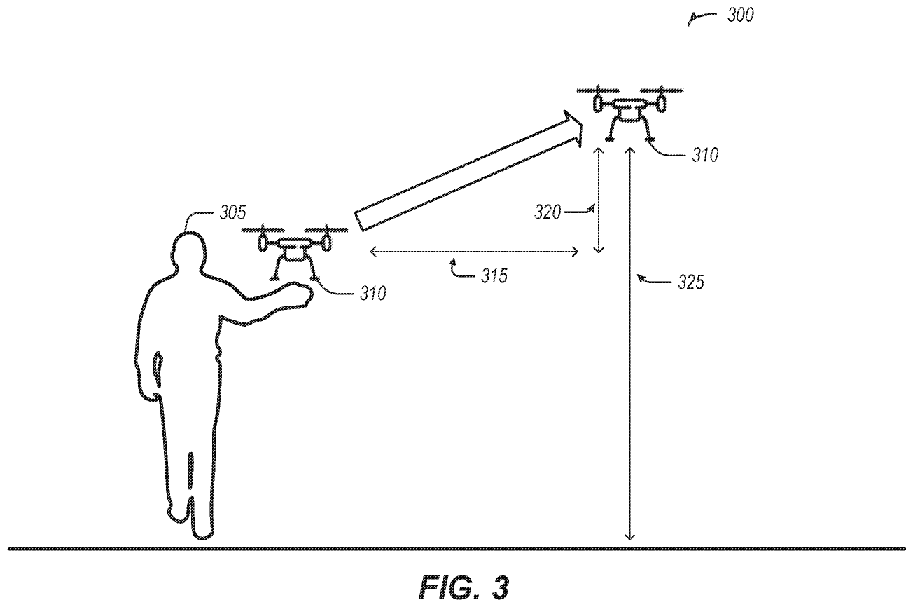

FIG. 3 illustrates an example 300 of an aerial camera device 310 in selfie mode, in accordance with some embodiments. In selfie mode the aerial camera device 310 may fly and take selfie photos and video autonomously while the user 305 stays immersed in an activity the user wants to capture. According to one embodiment, after take-off, aerial camera device 310 may fly away from the user 305 for five seconds, hover for one second, and then return to the user 305 and land. As the aerial camera device 310 flies away from the user 305, the aerial camera device 310 may keep at least one camera directed at the user 305. For example, the aerial camera device 310 may keep the selfie camera, or front facing camera, directed at the user 305, and thus may technically be flying backwards away from the user 305. While in flight, the aerial camera device 310 may either take selfie photos at intervals or record a selfie video of the user, during the entire flight automatically, or at a particular location (e.g., while hovering). The flight time away from the user 305 and the amount of time to hover and take photos or video before returning to the user 305 may each be customizable. In another example, the aerial camera device 310 may receive an initiation, take off by moving vertically (e.g., opposite a gravity vector), and then moving diagonally (e.g., traversing away from the user 305 and ascending).

In selfie mode, the aerial camera device 310 may use facial detection to lock on to the face of the user 305 and then maneuver itself to stay positioned so that the selfie camera stays facing the user. The facial detection process may be executed by the embedded control system of the aerial camera device 310. The facial detection may be based on facial characteristics learned and stored during initialization and training of the aerial camera device 310. Alternatively, the manual mode of operation may be complemented with facial detection flight control features.

In another embodiment, instead of flying away from the user 305 at a timed interval, the aerial camera device 310 may fly to a predefined relative distance (e.g., a distance in a direction perpendicular to a gravity vector or an absolute distance from the user 305). The aerial camera device 310 may fly away from the user to reach a predefined location relative to the user 305. When the selfie mode is activated, the aerial camera device 310 may fly a predefined distance 315 from the user, such as six feet from the user 305. The aerial camera device 310 may fly to a predefined altitude (e.g., simultaneously while flying away from the user 305). The altitude may be a take-off relative altitude 320, where the aerial camera device 310 climbs to an altitude relative to where it took off. For example, if the user 305 is holding the aerial camera device 310 in their hand, the aerial camera device may, climb three feet from that starting position. The altitude may be a ground relative altitude 325, where the aerial camera device 310 climbs to an altitude relative to the ground, without respect to the initial take-off position. For example, the aerial camera device may climb to six feet from the ground.

The aerial camera device 310 may have different predefined distances and altitudes for selfie mode compared to outdoor mode, as the aerial camera device 310 may be able to travel to greater distances and heights when outdoors. For example, when outdoor mode is activated, the aerial camera device 310 may travel to a predefined distance 315 of fifteen feet from the user 305 and a ground relative altitude 325 of ten feet. In outdoor mode, the aerial camera device 310 may use the bottom camera, or zenital camera, instead of the selfie camera to capture a wider image.

In the example 300, the user 305 may activate selfie mode or outdoor mode. The aerial camera device 310 may take-off and travel to a spatial position, such as at a predefined distance 315 and a predefined ground relative altitude 325. When the aerial camera device 310 reaches the spatial position, the aerial camera device 310 may begin to hover and perform a capture sequence, such as taking a photo or a video. When completed, the aerial camera device may return to the user 305 and begin a landing sequence. The aerial camera device 310 may land at a designated surface, such as the hand of the user 305, a tabletop, or the ground. In another example, the aerial camera device 310 may land by returning to a starting position, maintaining a particular distance to a surface (e.g., the user's hand or a floor) and turn off. The particular distance in this example may be a few millimeters, for example.

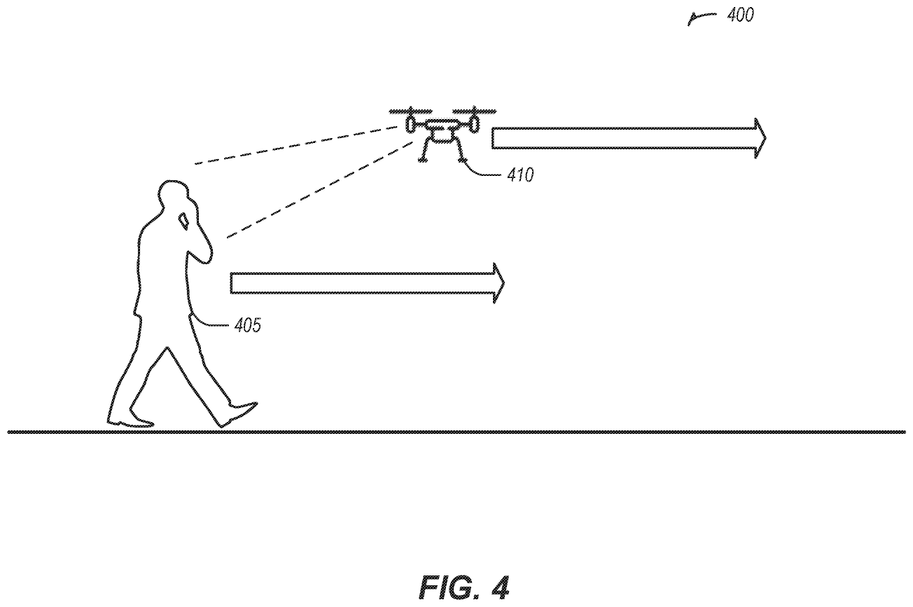

FIG. 4 illustrates an example 400 of an aerial camera device 410 in follow mode, in accordance with some embodiments. A user 405 may activate follow mode with the application on a connected smart phone. The follow mode may be activated when the aerial camera device 410 is not in use. In this scenario, the aerial camera device 410 may take-off and move to a spatial position similar to the selfie mode. The follow mode may be activated while the aerial camera device 410 is in use, such as while in a hover during selfie or manual mode.

When in follow mode, the aerial camera device 410 may stay focused on the user 405, such as by using facial detection. As the user 405 moves, the aerial camera device 410 moves with the user 405. The aerial camera device 410 may attempt to maintain a predefined distance from the user 405 during follow mode. For example, the aerial camera device 410 may maintain a distance of five feet from the user 405 during follow mode.

The term “follow” is used for follow mode as the aerial camera device 410 follows the movements of the user 405. However, as seen in example 400, the aerial camera device 410 may actually proceed the user 405. For example, the aerial camera device 410 may be intended to keep the face of the user 405 in focus with the camera, such as when capturing a video. As the user 405 walks forward, the user 405 will come closer to the aerial camera device 410, The aerial camera device 410 may detect this approach and begin to fly in the direction the user 405 is walking so that it may maintain the same distance from the user 405.

The aerial camera device may include additional modes that may be activated from the application on the connected smart phone. The aerial camera device may have a hover mode where the aerial camera device maintains a hover state (e.g., staying still while in flying) and captures photos or video. If equipped, the aerial camera device may use the bottom camera, or zenital camera, when in a hover state. The aerial camera device may have a complete zoom mode where the aerial camera device continuously takes photos or records video while going away from and coming back to the user.

The aerial camera device may include a continuous shooting mode where photos are taken at an interval, such as every three seconds, until an event occurs. The event may be pressing a stop button on the smart phone screen, performing a gesture that signals the aerial camera device, or the user moving out of the camera view. The aerial camera device may have a continuous recording mode where a video is recorded until an event occurs, similar to the continuous shooting mode. The aerial camera device may have a fixed shooting mode where a photo is taken at a fixed interval of time until a set number of photos have been captured. For example, a fixed shooting mode may be set to take a photo every two seconds until a total of ten photos have been captured. The aerial camera device may include a fixed recording mode where a video is captured for a set amount of time, such as sixty seconds.

The aerial camera device may include a calibration process, such as determining balance with the use of accelerometers and gyroscopes. The aerial camera device may include a battery for power and provide indication of the charge percentage for the battery. When the aerial camera device is in flight, it may have different states, such as taking off, landing, in flight, and idle or hovering. The aerial camera device may have different poses based on the displacement along the three axes and yaw rotation with respect to the initial taking off position, or an absolute roll and pitch value. The aerial camera device may include object detection and identify the distance the aerial camera device is with respect to the object. This may include detection of possible close objects on every side or on sides allowed by hardware set up and available sensors. The aerial camera device may have face detection and identify the face location in frame coordinates.

When the aerial camera device in being controlled manually, such as with the application on the smart phone, it may receive different commands. A command may be a joystick direction control, which may include flight control in all possible directions (x, y, z) and rotation axes (roll, pitch, yaw). Commands may include a take-off command, a landing command, and a reach initial position, which may include having the aerial camera device fly back to the initial position.

When the aerial camera device is in an automatic or one touch mode, settings may include a point to reach, such as given a predefined point the aerial camera device may automatically fly to the point. A setting may include yaw rotation as a predefined amplitude from an initial pose. A setting may include speed, such as a desired speed of flight. A setting may include a face tracking setting for the flight trajectory adjusting to keep the face in the frame.

For the different photo and video modes, the aerial camera device may have different parameters based on the mode. These may be customized by a user, such as through the application on the smart phone. The parameters may include the distance from the subject, which may be the distance between the face detected or tracked and the aerial camera device. The parameters may include the altitude, or the space between the aerial camera device and the ground. The parameters may include the camera type, such as either the selfie camera or the bottom camera. The aerial camera device may include additional cameras or cameras with features such as infrared or heat sensitivity. The parameters may include a rotation speed for when the aerial camera device is rotating around a subject for a 360 degree video. The parameters may include the flight speed. The flight speed may be set for when the aerial camera is not recording and for when it is recording a video or taking photos. The parameters may include a delay for starting to take photos or record a video once the aerial camera device reaches the designated distance and altitude. For example, a user may have a 5 second delay before a selfie photo is taken so they may pose. The parameters may include a duration for a video recording, such as a two minute recording.

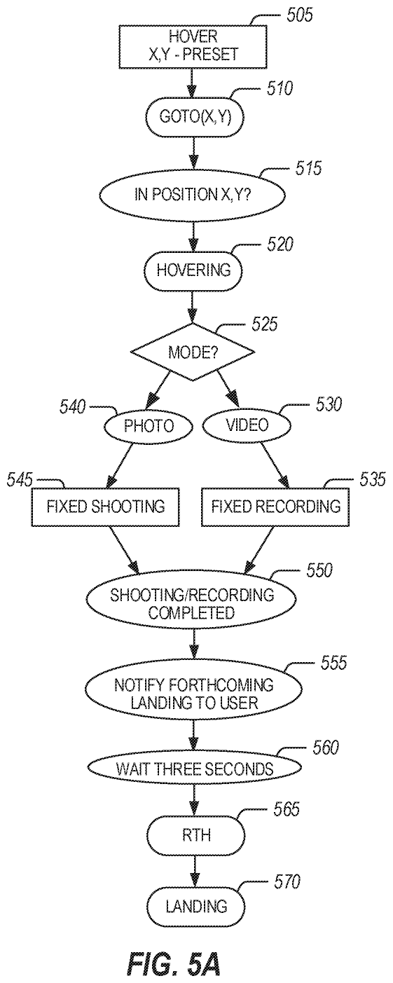

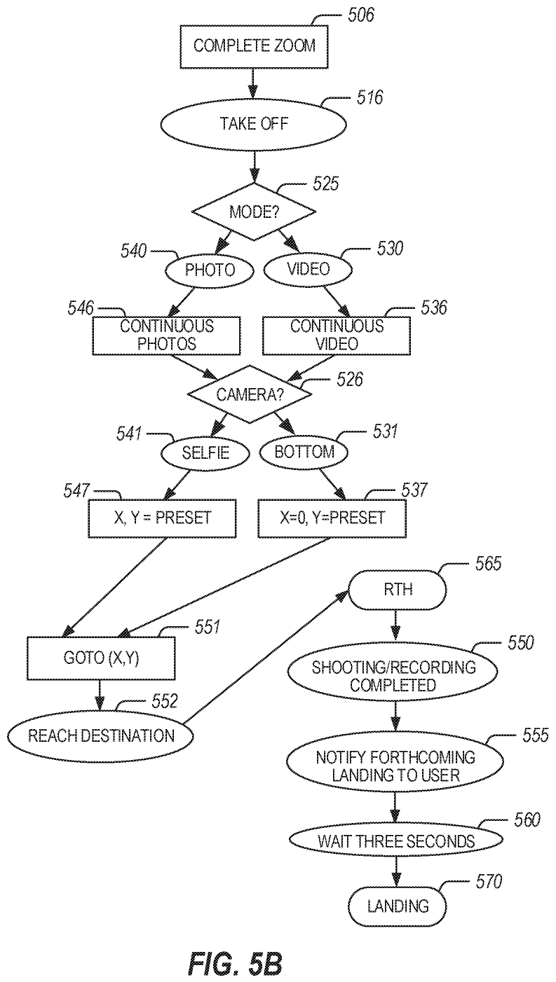

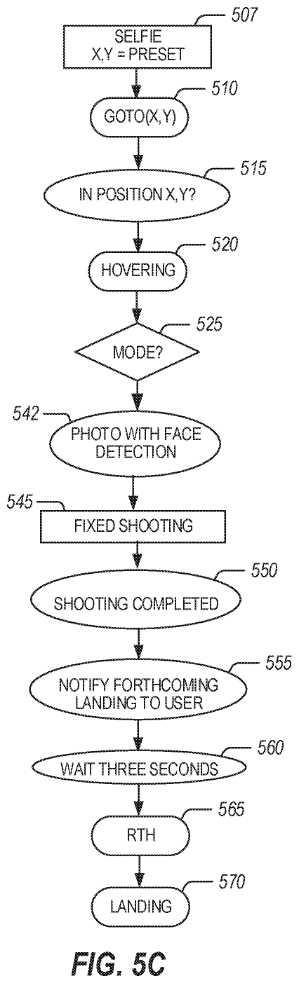

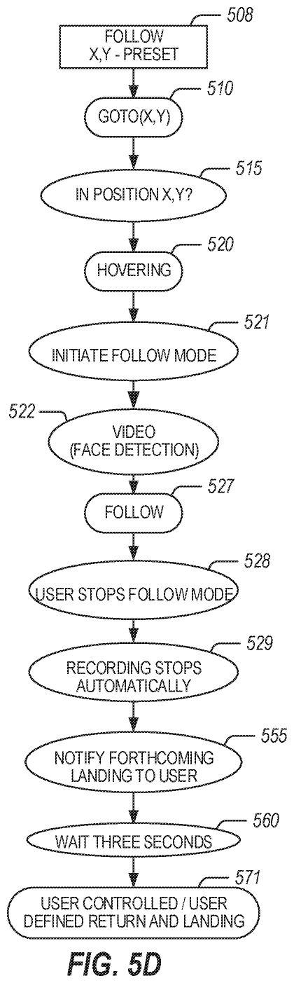

FIG. 5A illustrates an example hover process for a one touch hover mode of an aerial camera device, in accordance with some embodiments. The hover process may illustrate the actions performed for an aerial camera device to complete a selfie photo or video while hovering. At operation 505, the aerial camera device may receive a command to perform a hover. Operation 505 may include the command to perform a hover at a preset distance and altitude, x and y, and an indication if the selfie is indoors or outdoors. For example, if it is indoors, the x and y may be five meters and three meters, respectively, but if it is outdoors, the x and y may be fifteen meters and ten meters respectively.

When the hover mode is initiated, parameters in addition to the distance and altitude may be communicated to the aerial camera device. The hover mode may indicate to use the selfie, or forward facing, camera. There may be an indication of the number of photos to take, an interval between photos, the amount of time to take photos, or the length of video. A parameter may indicate the speed the aerial camera device should travel at.

At operation 510, the aerial camera device may travel to the preset distance and altitude. At operation 515, the aerial camera device determines if it is at the preset distance and altitude. This may be confirmed through the user of sensors or GPS. At operation 520, based on confirming the aerial camera device is at the correct position based on the preset distance and altitude, the aerial camera device enters a hover.

At decision 525, the aerial camera device determine if the capture mode is for photos or for video. At operation 540, the aerial camera device may capture a photo if the capture mode is for photos. Optionally, if the capture mode is for photos and a fixed shooting mode is selected, at operation 545 the aerial camera device may capture a fixed set of photos, such as at a timed interval. At operation 530, the aerial camera device may capture a video if the capture mode is for videos. Optionally, if the capture mode is for videos and a fixed recording mode is selected, at operation 535 the aerial camera device may capture a fixed recording length of video, such as for thirty seconds.

At operation 550, the aerial camera device may determine the photo shooting or video recording has completed. Based on determining the completion at operation 550, at operation 555, the aerial camera device may notify the user that the aerial camera device is landing. This may be performed by displaying a message on the smart phone used for controlling the aerial camera device. The notification may be a haptic feedback or audio alert from the smart phone. The notification may be communicated to a smart watch which may display the notification on a screen, provide haptic feedback, or an audio alert.

At operation 560, the aerial camera device may wait three seconds, or another determined interval of time, after sending the notification to then perform operation 565 and return to home. The home for the aerial camera device may be the location where it took off from, such as the hand of a user or a tabletop. At operation 570, the aerial camera device may perform a landing upon determine it is at the home or landing location.

FIG. 5B illustrates an example complete zoom process for a one touch complete zoom mode of an aerial camera device, in accordance with some embodiments. The complete zoom process may illustrate the actions performed for an aerial camera device to complete a set of continuous photos or video while the aerial camera device travels away from the user and then back to the user. At operation 506, the aerial camera device may receive a command to perform a continuous zoom. Operation 506 may include the command to perform the continuous zoom by flying to a preset distance and altitude, x and y, and an indication if the selfie is indoors or outdoors. Additional setting may include the speed the aerial camera device should travel while shooting the continuous photos or video, the delay between photos, and which camera to use.

At operation 516, the aerial camera device may take off and begin flight. At decision 525, the aerial camera device determine if the capture mode is for photos or for video. At operation 540, the aerial camera device may capture a continuous set of photos 546 if the capture mode is for photos. At operation 530, the aerial camera device may capture a continuous video 536 if the capture mode is for video.

At decision 526, the aerial camera device determines if the camera selected is the selfie camera 541 or bottom camera 531. Based on the camera selection, the destination for the aerial camera device performing the continuous zoom is determined. For the selfie camera 541, the aerial camera device travels to a preset distance and altitude 547. For the bottom camera 531, the aerial camera device may only travel upward from the user, thus providing the present altitude 537.

At operation 551, the aerial camera device flies to the distance and altitude provided from the presets based on selfie camera 541 or bottom camera 531. At determination 552, it is determined that the aerial camera device has reached the destination provided by the preset distance and altitude and thus completed the zoom out portion of the continuous zoom. Based on reaching the destination, a return to home operation 565 is initiated.

At operation 550, the aerial camera device may determine the photo shooting or video recording has completed, as it has returned to home and completed the zoom in portion of the continuous zoom. Based on determining the completion at operation 550, at operation 555, the aerial camera device may notify the user that the aerial camera device is landing. This may be performed by displaying a message on the smart phone used for controlling the aerial camera device. The notification may be a haptic feedback or audio alert from the smart phone. The notification may be communicated to a smart watch which may display the notification on a screen, provide haptic feedback, or an audio alert.

At operation 560, the aerial camera device may wait three seconds, or another determined interval of time, after sending the notification to then perform operation 570 and land. The home for the aerial camera device may be the location where it took off from, such as the hand of a user or a tabletop. At operation 570, the aerial camera device may perform a landing upon determine it is at the home or landing location.

FIG. 5C illustrates an example selfie process for a one touch selfie mode of an aerial camera device, in accordance with some embodiments. The selfie process may illustrate the actions performed for an aerial camera device to complete a selfie photo. At operation 507, the aerial camera device may receive a command to perform a selfie. Operation 507 may include the command to perform a selfie at a preset distance and altitude, x and y, and an indication if the selfie is indoors or outdoors. For example, if it is indoors, the x and y may be five meters and three meters, respectively, but if it is outdoors, the x and y may be fifteen meters and ten meters respectively.

When the selfie mode is initiated, parameters in addition to the distance and altitude may be communicated to the aerial camera device. The selfie mode may indicate to use the selfie, or forward facing, camera. There may be an indication of the number of photos to take, an interval between photos, or the amount of time to take photos.

At operation 510, the aerial camera device may travel to the preset distance and altitude. At operation 515, the aerial camera device determines if it is at the preset distance and altitude. This may be confirmed through the user of sensors or GPS. At operation 520, based on confirming the aerial camera device is at the correct position based on the preset distance and altitude, the aerial camera device enters a hover.

At decision 525, the aerial camera device determines the capture mode. As it is in selfie mode, the capture mode is for photos using face detection. At operation 542, the aerial camera device may capture a photo using face detection. The aerial camera device may confirm that a face is detected within the view of the selfie camera before beginning the photo capture sequence. Optionally, a fixed shooting mode may be used at operation 545 and the aerial camera device may capture a fixed set of photos, such as at a timed interval.

At operation 550, the aerial camera device may determine the photo shooting or video recording has completed. Based on determining the completion at operation 550, at operation 555, the aerial camera device may notify the user that the aerial camera device is landing. This may be performed by displaying a message on the smart phone used for controlling the aerial camera device. The notification may be a haptic feedback or audio alert from the smart phone. The notification may be communicated to a smart watch which may display the notification on a screen, provide haptic feedback, or an audio alert.

At operation 560, the aerial camera device may wait three seconds, or another determined interval of time, after sending the notification to then perform operation 565 and return to home. The home for the aerial camera device may be the location where it took off from, such as the hand of a user or a tabletop. At operation 570, the aerial camera device may perform a landing upon determine it is at the home or landing location.

FIG. 5D illustrates an example follow process for a one touch follow mode of an aerial camera device, in accordance with some embodiments. The follow process may illustrate the actions performed for an aerial camera device to complete a follow video. At operation 508, the aerial camera device may receive a command to perform a follow. Operation 508 may include the command to perform a follow at a preset distance and altitude, x and y, and an indication if the selfie is indoors or outdoors. For example, if it is indoors, the x and y may be five meters and three meters, respectively, but if it is outdoors, the x and y may be fifteen meters and ten meters respectively. The follow command may indicate the speed for the aerial camera device or if the aerial camera device should match the movement speed of the subject being followed.

At operation 510, the aerial camera device may travel to the preset distance and altitude. At operation 515, the aerial camera device determines if it is at the preset distance and altitude. This may be confirmed through the user of sensors or GPS. At operation 520, based on confirming the aerial camera device is at the correct position based on the preset distance and altitude, the aerial camera device enters a hover.

Upon entering the hover, the aerial camera device, at operation 521, may, initiate the follow mode. At operation 522, a video recording may be started that used face detection. With the use of face detection, the aerial camera device may maintain focus on the face for the duration of the recording. At operation 527, the aerial camera device may follow the subject while the video recording continues. The operation 527 of following the subject may include flying the aerial camera device to match movements of the subject while keeping the preset distance and altitude from the subject.

At operation 528, the user may stop the follow mode. This may be performed by the user initiating a stop procedure through an application on a smart phone. The user may make a gesture, such as closing their fist, to indicate that the video recording should end. At operation 529, based on receiving the indication from the user, the recording may automatically stop.

Based on determining the video recording has stopped, at operation 555, the aerial camera device may notify the user that the aerial camera device is landing. This may be performed by displaying a message on the smart phone used for controlling the aerial camera device. The notification may be a haptic feedback or audio alert from the smart phone. The notification may be communicated to a smart watch which may display the notification on a screen, provide haptic feedback, or an audio alert.

At operation 560, the aerial camera device may wait three seconds, or another determined interval of time, after sending the notification. At operation 571, the aerial camera device may return and land. As the user has possibly moved during the follow mode, the return and landing may need additional directives. This may be performed by a set of predefined instructions for landing after a follow mode, such as designating a known location for landing that does not change based on where the aerial camera device has travelled during the follow. Another option may be for the aerial camera device to enter a manual mode where the user may, control the flight and landing, such as with the joystick in the application on the smart phone. The user may control the landing with a gesture, such as moving both hands in a downward fashion to signal the aerial camera device should land.

An autonomous aerial camera device may include an example embodiment of a general mode of operation. In the general mode, the autonomous aerial camera device may receive a wake-up indication from an inertial measurement unit (IMU) of the autonomous aerial camera device. The autonomous aerial camera device may determine whether a mobile device or other computing device is connected, and if not, stay still for a time period (e.g., 15 seconds). If yes, the autonomous aerial camera device may start flying in a manual mode (e.g., controlled by a user). The user may select to manually fly or initiate a one-touch function mode. Either mode may include performing obstacle avoidance. During the one-touch function mode, when an obstacle is detected, the autonomous aerial camera device may avoid the obstacle using an infrared sensor, for example. The one-touch function mode may be paused, and the autonomous aerial camera device may hover in place for a period of time (e.g., 3 seconds). If the obstacle is no longer detected, the autonomous aerial camera device may restart or continue the routine initiated by the one-touch function mode. If the obstacle is still detected, the autonomous aerial camera device may attempt to move to avoid the obstacle. If the autonomous aerial camera device hits the obstacle or cannot complete the routine, the autonomous aerial camera device may return to a starting landing phase. If the autonomous aerial camera device was recording, material produced up to the point of collision or meeting an unavoidable object may be saved to the connected mobile device or computer.

An autonomous aerial camera device may include an example embodiment of low battery operation. When a low batter indication is identified, the autonomous aerial camera device may output a notification. When the autonomous aerial camera device is flying when the low battery indication is identified, the autonomous aerial camera device may notify the user continuously (e.g., every 5, 15, or 30 seconds). After a particular number of notifications (e.g., 3), the autonomous aerial camera device may end the routine automatically (e.g., land). When recording before or during the low battery incident, the autonomous aerial camera device may save the recording to a connected device.

An autonomous aerial camera device may include an example embodiment of the operation of when a communicatively connected app enters a background (e.g., a background mode operation on the smart phone operating system) or crashes. When the app crashes or enters a background, the autonomous aerial camera device may complete a routine, if running. When in a manual mode, the autonomous aerial camera device may stop (e.g., hover or land) and wait for a time period (e.g., 15 seconds). If the app returns, the autonomous aerial camera device may resume. If not, the autonomous aerial camera device may land at a starting point. An autonomous aerial camera device may include an example embodiment when a communicatively connected app is already operating in the background mode of operation. When the app is already in the background, the autonomous aerial camera device may be completing a routine, and may encounter an obstacle. In this example, the autonomous aerial camera device may perform obstacle avoidance as described above.

An autonomous aerial camera device may include an example embodiment when the connection is lost between a controller of the autonomous aerial camera device and a communicatively connected app. When the connection is lost, the autonomous aerial camera device may, if not flying, wait for a period of time before automatically turning off (e.g., 30 seconds). When flying, the autonomous aerial camera device may pause any routines currently running, or stop and wait for a period of time (e.g., 3 seconds). The autonomous aerial camera device may save any recordings and return to a starting landing phase.

An autonomous aerial camera device may include an example embodiment when the face detection is not working. When face detection is attempted, for example while the autonomous aerial camera device is flying and face tracking or detection is needed for a current function or routine, but a face cannot be detected, the autonomous aerial camera device may try for a period of time (e.g., 5 seconds), and then finish the current function or routine in position (e.g., hover without moving). In an example, more than one face may be detected. In this example, a median point between or among faces detected may be selected as a focus point for executing the function or routine.

An autonomous aerial camera device may include an example embodiment when the autonomous aerial camera device cannot maintain position. In this example, a connected app may notify a user (e.g., every 15 seconds), until a connection is achieved or a number of notifications or time out is reached. If no contact is established, the autonomous aerial camera device may automatically stop the flight routine, save any recording, and return to a landing point.

An autonomous aerial camera device may include an example embodiment when a top sensor detects an obstacle. When the autonomous aerial camera device is already at a target altitude, or within a particular range of the target altitude (e.g., within 10% of the target altitude), the autonomous aerial camera device may determine whether it is at a target distance, and if so perform the routine, and if not, move to the target distance. When the autonomous aerial camera device is not at the target altitude or within the particular range, the autonomous aerial camera device may output notifications (e.g., via the app) to a user, stop the routine, or land. If the autonomous aerial camera device is not at the target altitude or within the particular range, but has attained the target distance (or within a range, e.g., 10%), the autonomous aerial camera device may move horizontally (e.g., within a plane at a current altitude) to one quarter of the target distance (e.g., closer to the user) to try to reach the target altitude again.

An autonomous aerial camera device may include an example embodiment when a side sensor detects an obstacle. In this example, when the autonomous aerial camera device has attained the target distance (or is within a range), the autonomous aerial camera device may perform the routine (or if needed, move to the target altitude without moving horizontally, and then perform the routine). If the target distance and altitude have not yet been reached, the autonomous aerial camera device may notify the user, save recordings, or land. When the target distance has not yet been reached, but the target altitude has been reached, the autonomous aerial camera device may move vertically to one quarter of the target altitude and try to reach the target distance again.

An autonomous aerial camera device may include an example embodiment when two or more sensors (e.g., the top and the side sensors) detect an obstacle in an automated control mode (e.g., without user input). In this example, the autonomous aerial camera device may stop in a current position, notify the user (e.g., via the app), and move away until the object is no longer detected and complete the routine, or land.

An autonomous aerial camera device may include an example embodiment when top and side sensors detect an obstacle in a manual control mode. In the manual mode, the autonomous aerial camera device may stop in a current position, notify of a detected obstacle, move away, and wait for further user input.

The aerial camera device may be controlled using gestures. This may, provide an option for the user to control the aerial camera device without having to hold and look at the application on the smart phone. To initiate the gesture controlled takeoff and flight, the steps may include turning the aerial camera device on and pressing a button or sequence of buttons, such as double pressing the power button. The user may then point the camera, such as the selfie camera, of the aerial camera device at the user's face and then wait for the aerial camera device to automatically take off from the user's hand, upon detection of the user's face.

Once the aerial camera device has taken off under gesture control, it may perform a follow. The aerial camera device may follow the user through the use of face detection. The aerial camera device may keep the altitude and distance from the user as the user moves around so as to stay at a fixed distance and orientation from the user. The aerial camera device may correct the orientation so that it stays facing the user.

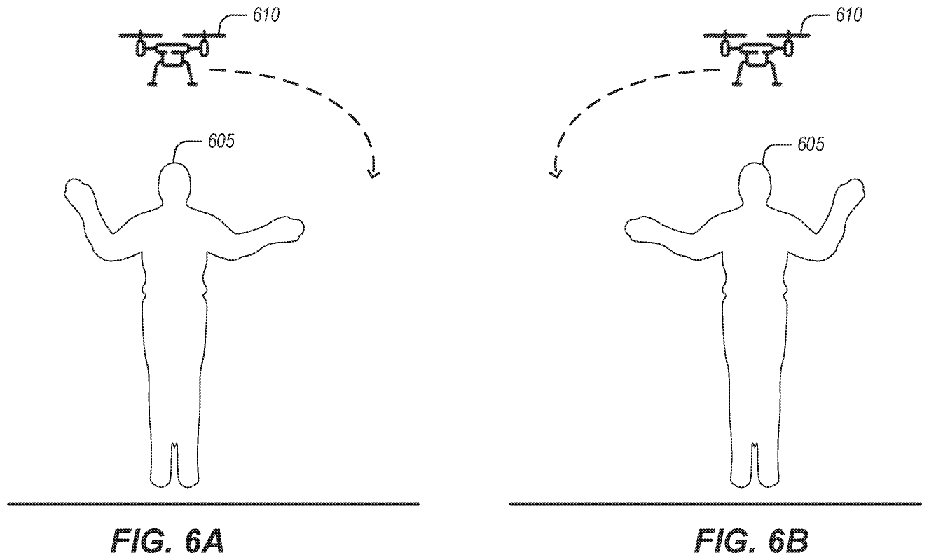

FIGS. 6A and 6B illustrate flight gestures for controlling the aerial camera device 610 to perform a side orbit, in accordance with some embodiments. FIGS. 6A and 6B are from a perspective behind the user 605 with the aerial camera device 610 in front of and facing the user 605. Using face and hands detection, the aerial camera device 610 may be commanded to orbit the user 605 in the direction the user indicates by holding both hands in the air and lowering one of the hands. The aerial camera device 610 may orbit in the direction of the lowered hand of the user 605. In FIG. 6A, the aerial camera device 610 may orbit to the right, or in a clockwise direction, when the user 605 lowers their right hand. In FIG. 6B, the aerial camera device 610 may orbit to the left, or in a counterclockwise direction, when the user 605 lowers their left hand. Both of the user's 605 hands are open to execute the gesture command. As the aerial camera device 610 orbits, it will stay oriented to face the user 605.

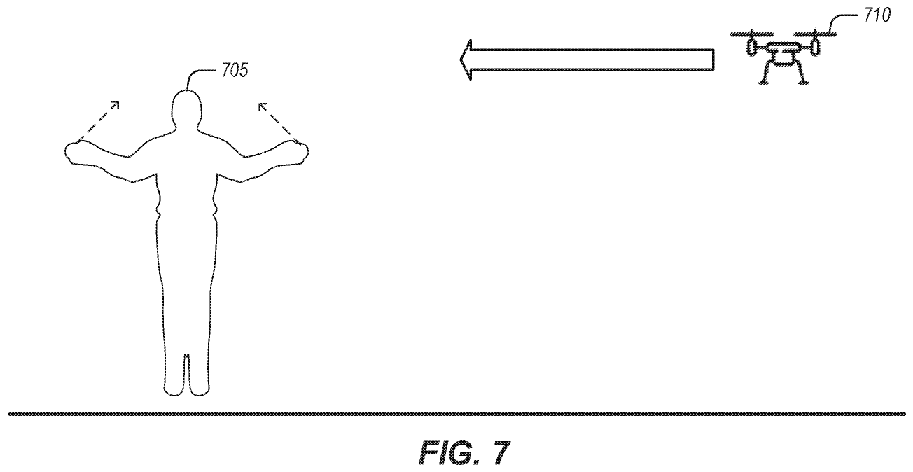

FIG. 7 illustrates a flight gesture for controlling the aerial camera device 710 to perform a zoom in, in accordance with some embodiments. The user 705 may use hand gestures to control the aerial camera device 710 to zoom in, or move closer to the user. Both of the user's 705 hands are open to execute the gesture command. The user 705 may begin the gesture command by starting with both open hands separated at shoulder height. The user 705 may then move the open hands closer together to activate the gesture command. As the open hands move together, the aerial camera device 710 may move closer to the user 705, while facing the user 705. This performance is completed through the use of face and hand detection.

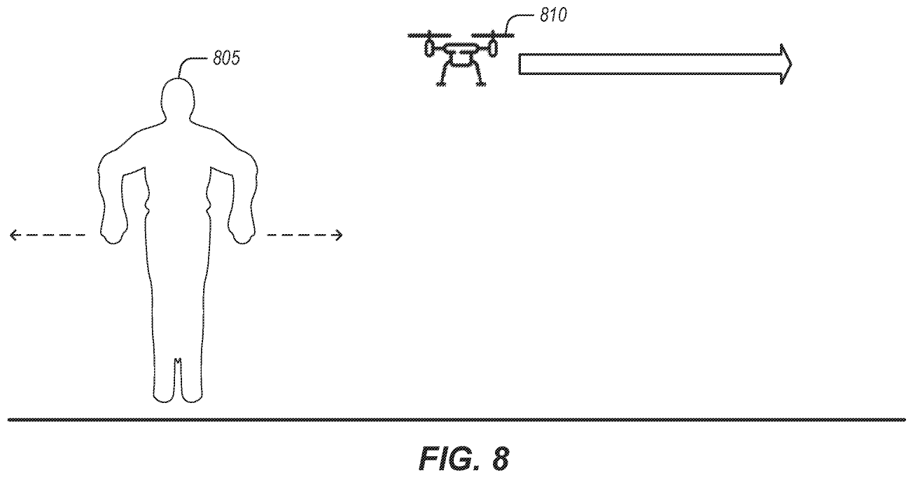

FIG. 8 illustrates a flight gesture for controlling the aerial camera device 810 to perform a zoom out, in accordance with some embodiments. The user 805 may use hand gestures to control the aerial camera device 810 to zoom out, or move farther away from the user 805. Both of the user's 805 hands are open to execute the gesture command. The user 805 may begin the gesture command by starting with both open hands close to each other. The user 805 may then separate their hands to activate the gesture command. As the user 805 separates their open hands, the aerial camera device 810 may move farther from the user 805 while still facing the user 805. This performance is completed through the use of face and hand detection.

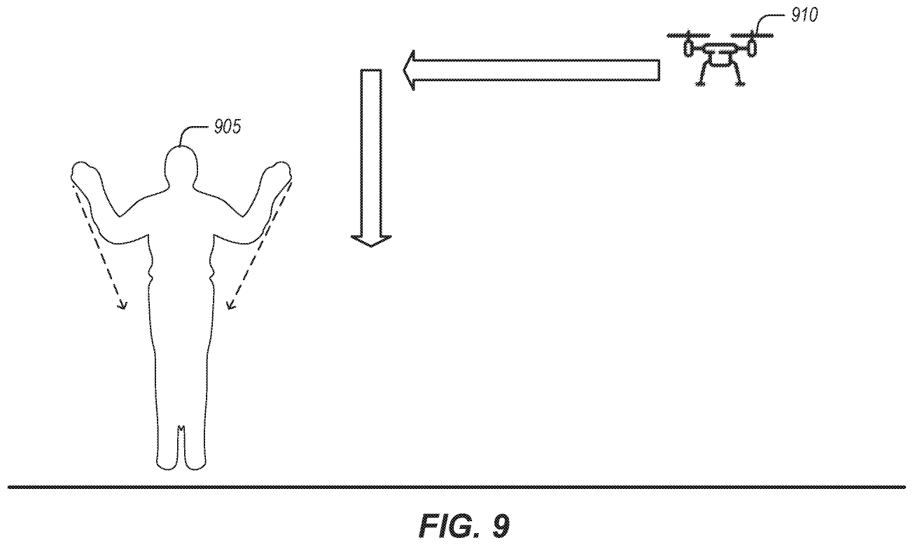

FIG. 9 illustrates a flight gesture for controlling the aerial camera device 910 to perform a landing, in accordance with some embodiments. Both of the user's 905 hands are open to execute the gesture command. The user 905 may start with open hands at shoulder height. The user 905 may move both open hands forward and downward toward the ground to activate the gesture command. The aerial camera device 910 may use face and hand detection to recognize the user 905 and the movement of the user's open hands. As the user 905 moves their open hands forward and downward, the aerial camera device may first begin to move closer to the user 905 and then may start moving downward toward the ground to land.

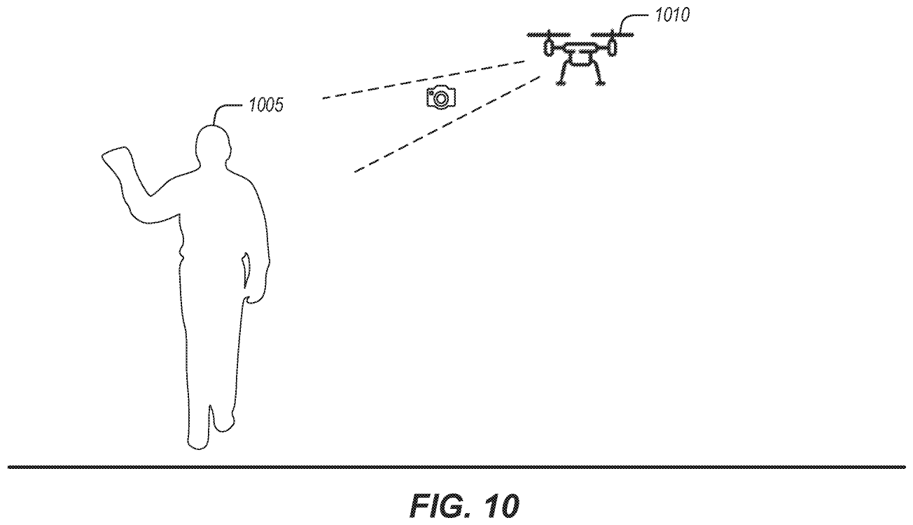

FIG. 10 illustrates a shooting gesture for taking a photo with the aerial camera device 1010, in accordance with some embodiments. While the aerial camera device is in a follow state, the user 1005 may raise their right hand with the hand open. The user 1005 may then close their hand to make a fist. The closure of the hand activates the shooting gesture and the aerial camera device 1010 may take a photo.

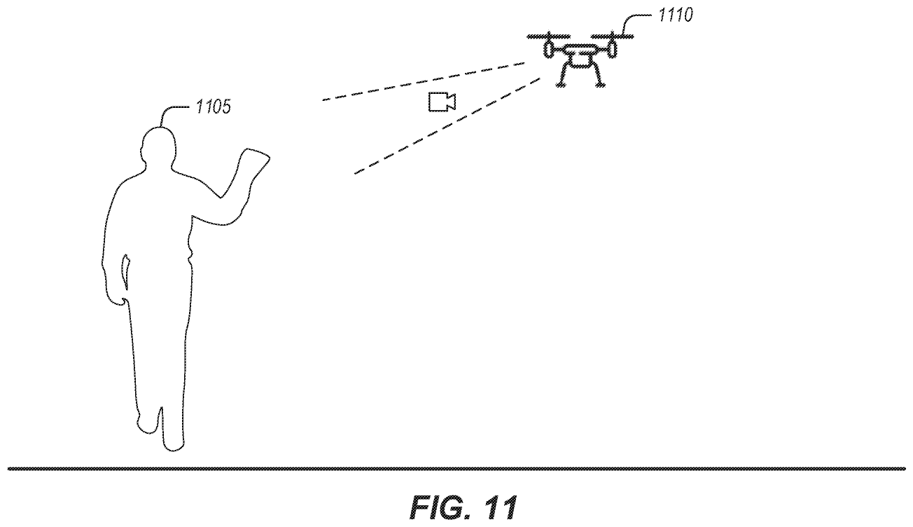

FIG. 11 illustrates a shooting gesture for taking a video with the aerial camera device 1110, in accordance with some embodiments. While the aerial camera device 1110 is in a follow state, the user 1105 may raise their left hand with the hand open. The user 1105 may then close their hand to make a fist. The closure of the hand activates the shooting gesture and the aerial camera device 1110 may start a video.

The shooting gestures of FIGS. 10 and 11 may be interchangeable. The shooting gestures of FIGS. 10 and 11 may not be limited to the gesture of making a first with the hand. A user may customize an activation for the shooting gesture to something of their preference, such as raising a finger.

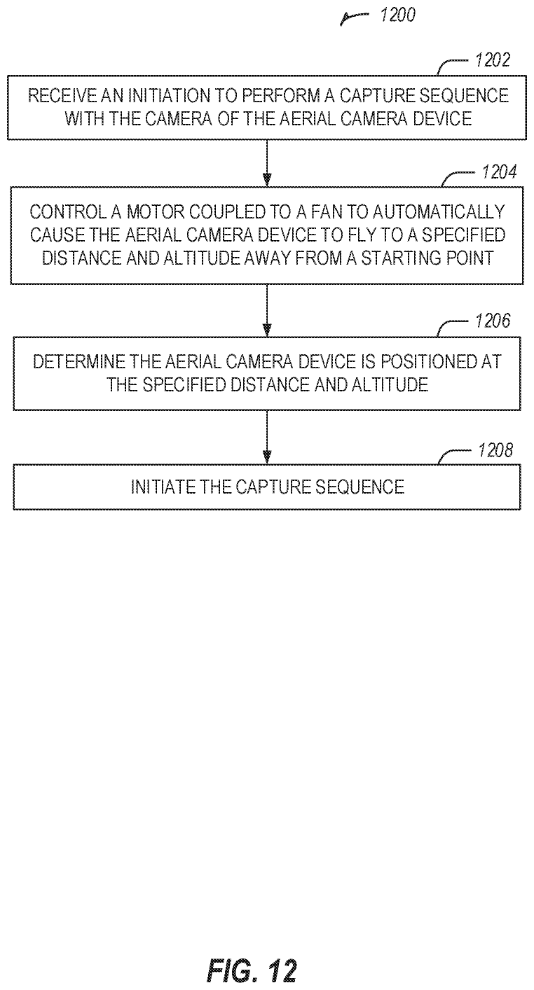

FIG. 12 illustrates a flow diagram of an example of a technique 1200 for a selfie aerial camera system, according to an embodiment. The technique 1200 may be performed by the selfie aerial camera device, which may include a camera, a motor, a propeller, or processing circuitry. The processing circuitry may be a system on a chip, include a processor, memory, hardwired circuitry, or the like. The technique 1200 includes an operation 1202 to receive an initiation to perform a capture sequence with a camera of the selfie aerial camera device. The initiation may be received as a wireless transmission from a mobile device operated by a user, such as a command provided to an application on a smart phone. The initiation may include a power on indication (e.g., button press on a hardware or soft power button of the selfie aerial camera device), such as with detection of a face. In other examples, receiving the initiation may include detecting a gesture. Upon receiving the initiation, a command to control the motor coupled to the propeller of the aerial camera device may automatically cause the aerial camera device to takeoff from a landing position.

The technique 1200 includes an operation 1204 to control a motor coupled to a propeller of the aerial camera device to automatically cause the aerial camera device to fly to a specified distance or altitude away from a starting point. The distance may be a specified absolute distance from a user or starting point or may be a distance horizontally away from a user or starting point (e.g., horizontal may mean within a plane that is perpendicular to a gravity vector).

The technique 1200 includes an operation 1206 to determine the aerial camera device is positioned at the specified distance or altitude. This determination may be performed by sensors of the aerial camera device. The technique 1200 may further include operations to determine the aerial camera device is outdoors and set the distance or the altitude based on the aerial camera device being outdoors. The technique 1200 may further include operations to determine the aerial camera device is indoors and set the distance or the altitude based on the aerial camera device being indoors.

The technique 1200 includes an operation 1208 to initiate the capture sequence. The capture sequence may include at least one of capturing an image with the camera or capturing a video with the camera. The capture sequence may include capturing a series of images at a timed interval. The capture sequence may include operations for detection of a face and upon detection of the face, capturing an image of the face with the camera. The capture sequence may further include operations to direct the aerial camera device to follow the user. The aerial camera device uses facial detection to follow the user. The capture sequence may include a series of operations to be executed by the selfie aerial camera device, such as movement, image or video capture, calibration, gesture identification, instruction reception, or the like, such as in any order or with repeated operations.

The technique 1200 further includes an operation to determine the capture sequence has completed, such as completing the number of images to capture or completing an elapsed time of video recording. The technique 1200 further includes an operation to control the motor coupled to the propeller to automatically cause the aerial camera device to fly to the starting point and execute a landing sequence.

The capture sequence of the technique 1200 further includes operations to receive images from the camera of a user and identify a gesture performed by the user. The technique 1200 further includes an operation to control the motor coupled to the propeller to automatically cause the aerial camera device to orbit around the user based on the gesture. The orbit may be clockwise or counterclockwise based on the gesture identified, such as lowering either the right or left hand when both hands are raised.

The technique 1200 further includes an operation to control the motor coupled to the propeller to automatically cause the aerial camera device to fly closer to the user or further away from the user based on the gesture. For example, the aerial camera device may fly away from the user if the user performs a gesture such as extending their arms outward. For example, the aerial camera device may fly toward the user if the user performs a gesture such as brining their arms together.

The technique 1200 further includes an operation to control the motor coupled to the propeller to automatically cause the aerial camera device to perform a landing based on the gesture. For example, the gesture identified may be the user with their hands positioned at shoulder height and bring both hands straight downward to indicate the aerial camera device should land.

The technique 1200 further includes an operation to automatically cause the camera to capture at least one of a photo or a video of the user based on the gesture. For example, the aerial camera device may take a photo if the user performs a gesture of making a first with their right hand. For example, the aerial camera device may record a video if the user performs a gesture of making a first with their left hand.

FIG. 13 illustrates a block diagram of an example machine 1300 upon which any one or more of the techniques (e.g., methodologies) discussed herein may perform. In alternative embodiments, the machine 1300 may operate as a standalone device or may be connected (e.g., networked) to other machines. In a networked deployment, the machine 1300 may operate in the capacity of a server machine, a client machine, or both in server-client network environments. In an example, the machine 1300 may act as a peer machine in peer-to-peer (P2P) (or other distributed) network environment. The machine 1300 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 1300 may include a hardware processor 1302 (e.g., a central processing unit (CPU), a graphics processing unit (GPU), a hardware processor core, field programmable gate array (FPGA), or any combination thereof), memory 1304 and a static memory 1306, some or all of which may communicate with each other via an interlink (e.g., bus) 1308. The machine 1300 may further include a display unit 1310, an alphanumeric input device 1312 (e.g., a keyboard), and a user interface (UI) navigation device 1314 (e.g., a mouse). In an example, the display unit 1310, input device 1312 and UI navigation device 1314 may be a touch screen display. The machine 1300 may additionally include a storage device (e.g., drive unit) 1316, a signal generation device 1318 (e.g., a speaker), a network interface device 1320, and one or more sensors 1321, such as a global positioning system (GPS) sensor, compass, accelerometer, or other sensor. The machine 1300 may include an output controller 1328, such as a serial (e.g., universal serial bus (USB), parallel, or other wired or wireless (e.g., infrared (IR), near field communication (NEC), etc.) connection to communicate or control one or more peripheral devices (e.g., a printer, card reader, etc.).

The storage device 1316 may include a machine readable medium 1322 on which is stored one or more sets of data structures or instructions 1324 (e.g., software) embodying or used by any one or more of the techniques or functions described herein. The instructions 1324 may also reside, completely or at least partially, within the main memory 1304, within static memory 1306, or within the hardware processor 1302 during execution thereof by the machine 1300. In an example, one or any combination of the hardware processor 1302, the main memory 1304, the static memory 1306, or the storage device 1316 may constitute machine readable media.

While the machine readable medium 1322 is illustrated as a single medium, the term “machine readable medium” may include a single medium or multiple media (e.g., a centralized or distributed database, and/or associated caches and servers) configured to store the one or more instructions 1324.

The term “machine readable medium” may include any medium that is capable of storing, encoding, or carrying instructions for execution by the machine 1300 and that cause the machine 1300 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1324 may further be transmitted or received over a communications network 1326 using a transmission medium via the network interface device 1320 utilizing any one of a number of transfer protocols (e.g., frame relay, Internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1320 may include one or more physical jacks (e.g., Ethernet, coaxial, or phone jacks) or one or more antennas to connect to the communications network 1326. In an example, the network interface device 1320 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1300, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

Example 1 is an aerial camera device, comprising: a camera; and processing circuitry to: receive an initiation to perform a capture sequence with the camera; control a motor coupled to a propeller to automatically cause the aerial camera device to fly to a specified distance and altitude away from a starting point; determine the aerial camera device is positioned at the specified distance and altitude; and initiate the capture sequence.

In Example 2, the subject matter of Example 1 includes, wherein the capture sequence includes at least one of capturing an image with the camera or capturing a video with the camera.

In Example 3, the subject matter of Examples 1-2 includes, wherein the capture sequence includes: detection of a face; and upon detection of the face, capturing an image of the face with the camera.

In Example 4, the subject matter of Examples 1-3 includes, wherein the initiation is received as a wireless transmission from a mobile device operated by a user.

In Example 5, the subject matter of Examples 1-4 includes, wherein the capture sequence further includes instructions to direct the aerial camera device to follow a user.

In Example 6, the subject matter of Example 5 includes, wherein the aerial camera device uses facial detection to follow the user.

In Example 7, the subject matter of Examples 1-6 includes, the processing circuitry further to: determine the capture sequence has completed; control the motor coupled to the propeller to automatically cause the aerial camera device to fly to the starting point; and execute a landing sequence.

In Example 8, the subject matter of Examples 1-7 includes, the processing circuitry further to: determine the aerial camera device is outdoors; and set the distance and the altitude based on the aerial camera device being outdoors.

In Example 9, the subject matter of Examples 1-8 includes, wherein the initiation includes a power on indication and detection of a face by the camera.

In Example 10, the subject matter of Example 9 includes, wherein upon detection of the face, the processing circuitry is further to control the motor coupled to the propeller to automatically cause the aerial camera device to takeoff from a landing position.

In Example 11, the subject matter of Examples 1-10 includes, wherein the capture sequence includes the processing circuitry further to: receive images from the camera of a user; and identify a gesture performed by the user.

In Example 12, the subject matter of Example 11 includes, the processing circuitry further to control the motor coupled to the propeller to automatically cause the aerial camera device to orbit around the user based on the gesture.

In Example 13, the subject matter of Examples 11-12 includes, the processing circuitry further to control the motor coupled to the propeller to automatically cause the aerial camera device to fly closer to the user or further away from the user based on the gesture.

In Example 14, the subject matter of Examples 11-13 includes, the processing circuitry further to control the motor coupled to the propeller to automatically cause the aerial camera device to perform a landing based on the gesture.

In Example 15, the subject matter of Examples 11-14 includes, the processing circuitry further to automatically cause the camera to capture at least one of a photo or a video of the user based on the gesture.

Example 16 is a method for a capture sequence with an aerial camera device, comprising: receiving an initiation to perform the capture sequence with a camera of the aerial camera device; controlling a motor coupled to a propeller to automatically cause the aerial camera device to fly to a specified distance and altitude away from a starting point; determining the aerial camera device is positioned at the specified distance and altitude; and initiating the capture sequence.

In Example 17, the subject matter of Example 16 includes, wherein the capture sequence includes at least one of capturing an image with the camera or capturing a video with the camera.

In Example 18, the subject matter of Examples 16-17 includes, determining the capture sequence has completed; controlling the motor coupled to the propeller to automatically cause the aerial camera device to fly to the starting point; and executing a landing sequence.

In Example 19, the subject matter of Examples 16-18 includes, the capture sequence further comprising: receiving images from the camera of a user; and identifying a gesture performed by the user.

In Example 20, the subject matter of Example 19 includes, controlling the motor coupled to the propeller to automatically cause the aerial camera device to orbit around the user based on the gesture.

In Example 21, the subject matter of Examples 19-20 includes, controlling the motor coupled to the propeller to automatically cause the aerial camera device to fly closer to the user or further away from the user based on the gesture.

In Example 22, the subject matter of Examples 19-21 includes, controlling the motor coupled to the propeller to automatically cause the aerial camera device to perform a landing based on the gesture.

In Example 23, the subject matter of Examples 19-22 includes, automatically causing the camera to capture at least one of a photo or a video of the user based on the gesture.

Example 24 is at least one non-transitory machine-readable medium including instructions for a capture sequence with an aerial camera device, that when executed by the processing circuitry, cause the processing circuitry to: receive an initiation to perform the capture sequence with a camera of the aerial camera device; control a motor coupled to a propeller to automatically cause the aerial camera device to fly to a specified distance and altitude away from a starting point; determine the aerial camera device is positioned at the specified distance and altitude; and initiate the capture sequence.

In Example 25, the subject matter of Example 24 includes, wherein the instructions further cause the processing circuitry to: determine the capture sequence has completed; control the motor coupled to the propeller to automatically cause the aerial camera device to fly to the starting point; and execute a landing sequence.

Example 26 is at least one machine-readable medium including instructions that, when executed by processing circuitry, cause the processing circuitry to perform operations to implement of any of Examples 1-25.

Example 27 is an apparatus comprising means to implement of any of Examples 1-25.

Example 28 is a system to implement of any of Examples 1-25.

Example 29 is a method to implement of any of Examples 1-25.

What is claimed:

1. An aerial camera device, comprising:
a camera; and
processing circuitry to:
receive an initiation to perform a capture sequence with the camera;
control a motor coupled to a propeller to automatically cause the aerial camera device to fly to a specified distance and altitude away from a starting point;
determine the aerial camera device is positioned at the specified distance and altitude; and
initiate the capture sequence.

2. The aerial camera device of claim 1, wherein the capture sequence includes at least one of capturing an image with the camera or capturing a video with the camera.

3. The aerial camera device of claim 1, wherein the capture sequence includes:
detection of a face; and
upon detection of the face, capturing an image of the face with the camera.

4. The aerial camera device of claim 1, wherein the initiation is received as a wireless transmission from a mobile device operated by a user.

5. The aerial camera device of claim 1, wherein the capture sequence further includes instructions to direct the aerial camera device to follow a user.

6. The aerial camera device of claim 5, wherein the aerial camera device uses facial detection to follow the user.

7. The aerial camera device of claim 1, the processing circuitry further to:
determine the capture sequence has completed;
control the motor coupled to the propeller to automatically cause the aerial camera device to fly to the starting point; and
execute a landing sequence.

8. The aerial camera device of claim 1, the processing circuitry further to:
determine the aerial camera device is outdoors; and
set the distance and the altitude based on the aerial camera device being outdoors.

9. The aerial camera device of claim 1, wherein the initiation includes power on indication and detection of a face by the camera.

10. The aerial camera device of claim 9, wherein upon detection of the face, the processing circuitry is further to control the motor coupled to the propeller to automatically cause the aerial camera device to takeoff from a landing position.

11. A method for a capture sequence with an aerial camera device, comprising:
receiving an initiation to perform the capture sequence with a camera of the aerial camera device;
controlling a motor coupled to a propeller to automatically cause the aerial camera device to fly to a specified distance and altitude away from a starting point;
determining the aerial camera device is positioned at the specified distance and altitude; and
initiating the capture sequence.

12. The method of claim 11, wherein the capture sequence includes at least one of capturing an image with the camera or capturing a video with the camera.

13. The method of claim 11, further comprising:
determining the capture sequence has completed;
controlling the motor coupled to the propeller to automatically cause the aerial camera device to fly to the starting point; and
executing a landing sequence.

14. The method of claim 11, the capture sequence further comprising:
receiving images from the camera of a user; and
identifying a gesture performed by the user.

15. The method of claim 14, further comprising controlling the motor coupled to the propeller to automatically cause the aerial camera device to orbit around the user based on the gesture.

16. The method of claim 14, further comprising controlling the motor coupled to the propeller to automatically cause the aerial camera device to fly closer to the user or further away from the user based on the gesture.

17. The method of claim 14, further comprising controlling the motor coupled to the propeller to automatically cause the aerial camera device to perform a landing based on the gesture.

18. The method of claim 14, further comprising automatically causing the camera to capture at least one of a photo or a video of the user based on the gesture.

19. At least one non-transitory machine-readable medium including instructions for a capture sequence with an aerial camera device, that when executed by processing circuitry, cause the processing circuitry to:
receive an initiation to perform the capture sequence with a camera of the aerial camera device;
control a motor coupled to a propeller to automatically cause the aerial camera device to fly to a specified distance and altitude away from a starting point;
determine the aerial camera device is positioned at the specified distance and altitude; and
initiate the capture sequence.

20. The at least one machine-readable medium of claim 19, wherein the instructions further cause the processing circuitry to:
determine the capture sequence has completed;
control the motor coupled to the propeller to automatically cause the aerial camera device to fly to the starting point; and
execute a landing sequence.
